(19) United States
(12) Patent Application Publication
(10) Pub. No.: US 2024/0277571 A1
(43) Pub. Date: Aug. 22, 2024

(54) MULTIPLE CELL PILLBOXES WITH CLOSURE MECHANISMS

(71) Applicant: Bytech IP Holdings, LLC, Brooklyn, NY (US)

(72) Inventors: Victor Mizrahi, Brooklyn, NY (US); Solomon Mizrahi, Brooklyn, NY (US); Eli Mizrahi, Brooklyn, NY (US); Daniel Mizrahi, Brooklyn, NY (US)

(21) Appl. No.: 18/537,126

(22) Filed: Dec. 12, 2023

Related U.S. Application Data
(63) Continuation-in-part of application No. 29/801,778, filed on Jul. 30, 2021, now Pat. No. D007138.
(63) Continuation-in-part of application No. 29/801,791, filed on Jul. 30, 2021, now Pat. No. D007139.

(51) Int. Cl. A61J 1/03

(52) U.S. Cl. CPC A61J 1/03

(57) ABSTRACT

A multi-cell pillbox is presented, comprising a base portion comprising a set of N cells organized in one or more rows, each row including M cells, and i top cover portions configured to respectively fit over the N cells, where i is a number of rows of the base portion. In embodiments, each cover portion includes an individual cover for each of the M cells, the M individual covers configured to respectively close over M cells in a row of the base portion, each individual cover including a slot, configured to receive an insert. In embodiments, in a front portion of each cell of the base portion, there is provided a push tab connected to the base portion via a flexible member, the push tab including, at a rear portion thereof, a protrusion, the protrusion configured to be inserted into a slot of a corresponding individual cover for that cell.

### CROSS-REFERENCE TO OTHER APPLICATIONS

This application is a continuation-in-part of, and claims priority to, each of U.S. Design patent application Ser. No. 29/801,778, filed on Jul. 30, 2021, which will issue as U.S. Design Pat. No. D1007138 on Dec. 12, 2023, and U.S. Design patent application Ser. No. 29/801,791, also filed on Jul. 30, 2021, which will issue as U.S. Design Patent No. D1007139, also on Dec. 12, 2023.

### TECHNICAL FIELD

The present invention is directed to multiple day pill and medication organizers, and in particular to multiple cell pillboxes having one or more rows of cells, each cell having an easy to use opening and closure mechanism.

### BACKGROUND OF THE INVENTION

With the life expectancy of the U.S. population increasing, many Americans take multiple medications daily, for years. Some are on regimens of medication (and sometimes supplements), for literally decades. At the same time as their pharmaceutical regimen increases, seniors often also encounter slowing or degrading cognitive abilities.

Additionally, many individuals take several sets of pills at regular times throughout the day. Thus, such individuals may require, for each day, an organized set of pills to take morning and evening, or even at four different times each day.

What is needed is a convenient device to organize medications for all such users, each according to their needs and times per day requirements.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a top and front perspective view of a single row seven day pill box according to an embodiment.

FIG. 2 is a front view of the single row pillbox.

FIG. 3 is a rear view of the single row pillbox.

FIG. 4 is a left side view (viewer's perspective) of the single row pillbox.

FIG. 5 is a right side view (viewer's perspective) of the single row pillbox.

FIG. 6 is a top view of the single row pillbox.

FIG. 7 is a bottom view of the single row pillbox.

FIG. 8 is a top and front perspective view of a double row seven day pill box according to an embodiment.

FIG. 9 is a front view of the double row pillbox.

FIG. 10 is a rear view of the double row pillbox.

FIG. 11 is a left side view (viewer's perspective) of the double row pillbox.

FIG. 12 is a right side view (viewer's perspective) of the double row pillbox;

FIG. 13 is a top view of the double row pillbox.

FIG. 14 is a bottom view of the double row pillbox.

FIG. 15 is a top, front and right side perspective view of an exemplary four row seven day pill box according to an embodiment.

FIG. 16 is a top, rear and left side perspective view of the four row pillbox.

FIG. 17 is a top and left side perspective view of the four row pillbox.

FIG. 18 is a front view of the four row pillbox.

FIG. 19 is a rear view of the four row pillbox.

FIG. 20 is a left side view (viewer's perspective) of the four row pillbox.

FIG. 21 is a right side view (viewer's perspective) of the four row pillbox.

FIG. 22 is a top view of the four row pillbox.

FIG. 23 is a bottom view of the four row pillbox.

FIG. 24 provides example dimensions for an exemplary 7 cell single row pillbox, according to an embodiment.

FIG. 25 illustrates details of the single row pillbox of FIG. 24.

FIG. 26A illustrates the thin surface hinge of the upper cover, and example closed and open configurations of the pillbox.

FIG. 26B illustrates opening and closing details of the single row pillbox of FIG. 26A.

FIG. 27A illustrates the open and closed states of the single row pillbox of FIG. 24.

FIG. 27B illustrates the upper cover rebound force of the single row pillbox.

FIG. 27C illustrates details of the hinge structure of the single row pillbox.

FIG. 28A illustrates the single row pillbox of FIG. 24 in a closed position.

FIG. 28B shows a magnified version of the slot and buckle mechanism of FIG. 28A.

FIG. 28C shows a further magnified view of the buckle and slot of FIG. 28B.

FIG. 29A illustrates an initial user action to open an exemplary cell of the single row pillbox.

FIG. 29B illustrates how the buckle is moved backwards, thereby releasing it from the slot.

FIG. 29C illustrates the upper cover of the pillbox cell popping open as a result of the upper cover now being freed.

FIG. 30 provides example dimensions for a base portion of an exemplary 7 cell double row pillbox, according to an embodiment.

FIG. 31 provides example dimensions for a cover portion of the exemplary 7 cell double row pillbox, according to an embodiment.

FIG. 32 depicts an example embodiment of a double row pillbox with a white base portion, and two cover portions, one light green, the other dark green, according to an embodiment.

FIG. 33 depicts a user starting to push down on an exemplary push button of one cell of the base portion to release an upper cover corresponding to that cell.

FIG. 34 depicts the user of FIG. 33 completing the exemplary release action and the upper cover popping up.

FIG. 35 illustrates the upper cover shown in FIG. 34 fully popped up, available for the user to easily compete opening the cell.

FIG. 36 illustrates assembly of an exemplary two cover portions and a two row base portion, according to an embodiment.

FIG. 37 illustrates FIG. 37 illustrates the example two row pill box of FIG. 36, as assembled.

FIG. 38A illustrates, from left to right, the thin hinge structure connecting the upper cover and the portion of the upper cover that is snapped into the base portion, and the closed and open positions of the upper cover portion for an entire row of pill cells, according to an embodiment.

FIG. 38B illustrates an enlarged view of the base portion and upper cover portion of FIG. 38A in each of the closed and open positions for a single cell.

FIG. 39 provides example dimensions for a base portion of an exemplary 7 cell four row pillbox, according to an embodiment.

FIG. 40 provides example dimensions for a cover portion of the exemplary 7 cell four row pillbox of FIG. 39, according to an embodiment.

FIG. 41A illustrates exemplary upper covers and a single base for an exemplary 7 cell four row pillbox, according to an embodiment.

FIG. 41B illustrates the four row pillbox of FIG. 41A in a closed state.

FIG. 42 depicts an example embodiment of a four row pillbox with a white base portion, and four colored cover portions, allowing a user to distinguish each row, according to an embodiment.

FIG. 43 illustrates assembly of an example four row seven day pillbox, in accordance with an embodiment.

FIG. 44 illustrates exemplary dimensions for an example one row pillbox according to an alternate embodiment having rounded corners, and where the cover, when closed, completes a clean and sleek perimeter together with the base.

FIG. 45A illustrates an implementation of the one row pillbox of FIG. 44 in an open state.

FIG. 45B illustrates the one row pillbox of FIG. 45A in a closed state.

FIG. 46A shows the example one row pillbox of FIG. 45 in each of open and closed states.

FIG. 46B shows the one row pillbox having popped up after release of the upper cover.

FIG. 46C shows detail of an example thin hinge for the one row pillbox.

FIG. 47A shows detail of the front wall of the cell and the buckle on the push button, according to an embodiment.

FIG. 47B shows an underside view of the structures in FIG. 47A.

FIG. 48 illustrates a perspective view of the opening of a cell of the example pillbox of FIG. 45 from a closed state to the upper cover pop up state.

FIG. 49A shows top and bottom views of an example pillbox with a closure mechanism according to an embodiment.

FIG. 49B shows top and bottom renderings of the example pillbox of FIG. 49A, showing areas to be enlarged to illustrate the closure mechanism.

FIG. 49C shows the indicated enlarged areas of the top and bottom renderings of FIG. 49B.

FIG. 50A shows top and bottom renderings of an example pillbox with an alternate closure mechanism according to an alternate embodiment.

FIG. 50B shows top and bottom renderings of the example pillbox of FIG. 50A, showing areas to be enlarged to illustrate the alternate closure mechanism.

FIG. 50C shows the indicated enlarged areas of the top and bottom renderings of FIG. 50B.

### DETAILED DESCRIPTION OF THE INVENTION

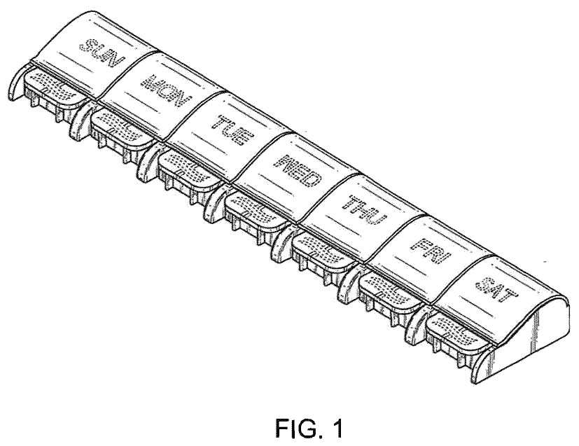

FIG. 1 is a top and front perspective view of an example single row seven day pill box according to an embodiment. The term single row refers to the placement of all seven pill cells adjacent to one another in a single row.

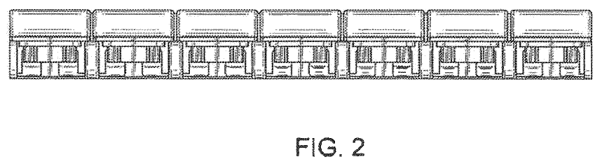

FIG. 2 is a front view of the single row pillbox.

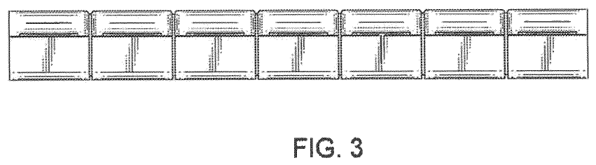

FIG. 3 is a rear view of the single row pillbox.

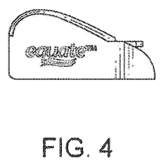

FIG. 4 is a left side view (viewer's perspective) of the single row pillbox.

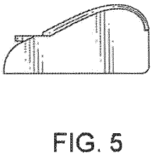

FIG. 5 is a right side view (viewer's perspective) of the single row pillbox.

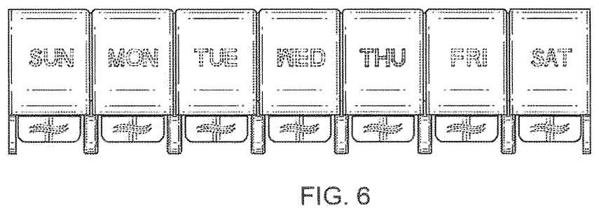

FIG. 6 is a top view of the single row pillbox.

FIG. 7 is a bottom view of the single row pillbox.

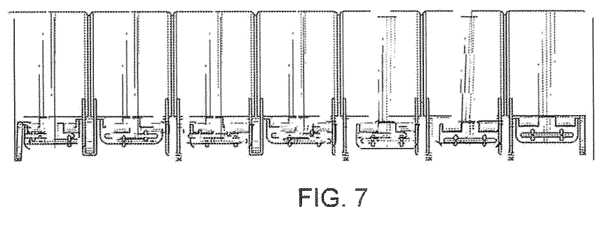

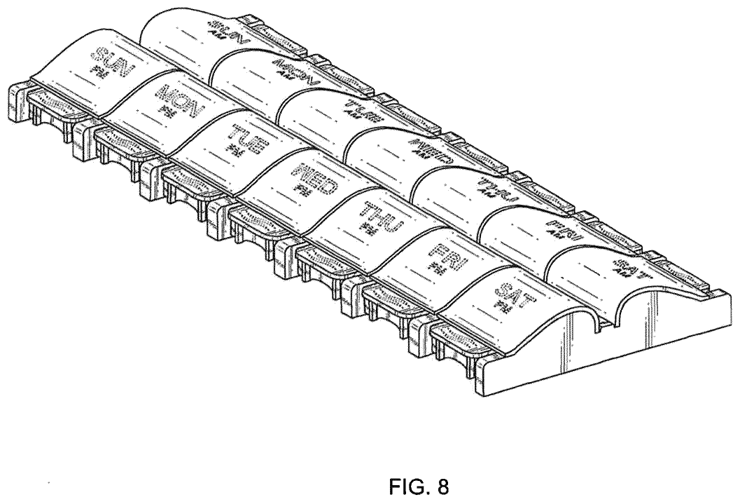

FIG. 8 is a top and front perspective view of a double row seven day pill box, according to an embodiment.

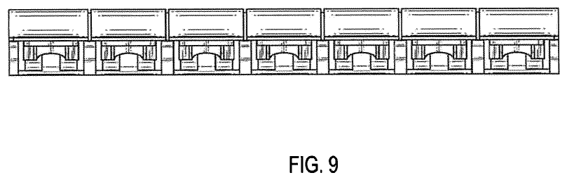

FIG. 9 is a front view of the double row pillbox.

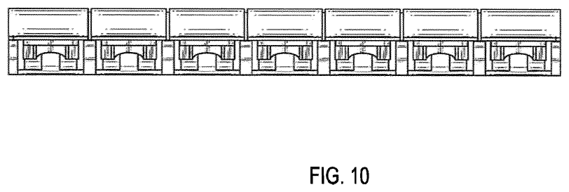

FIG. 10 is a rear view of the double row pillbox.

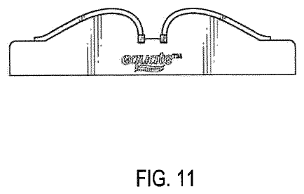

FIG. 11 is a left side view (viewer's perspective) of the double row pillbox.

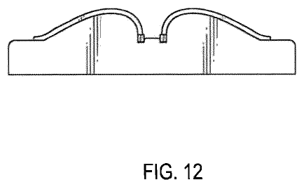

FIG. 12 is a right side view (viewer's perspective) of the double row pillbox;

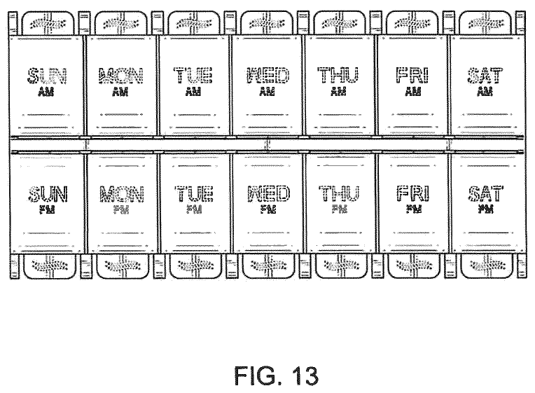

FIG. 13 is a top view of the double row pillbox.

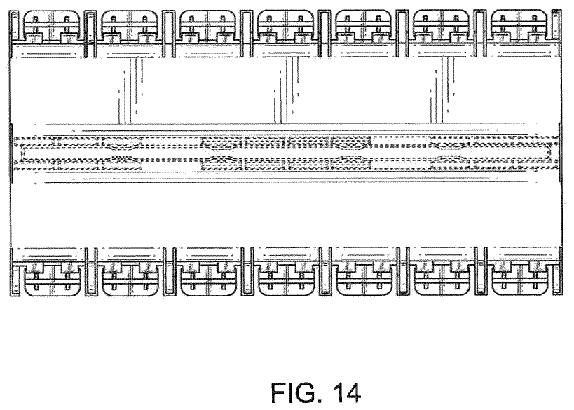

FIG. 14 is a bottom view of the double row pillbox.

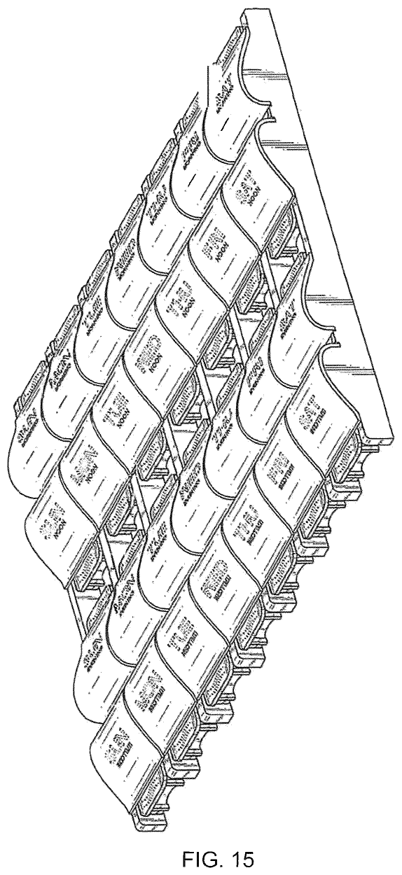

FIG. 15 is a top, front and right side perspective view of an exemplary four row seven day pill box, according to an embodiment.

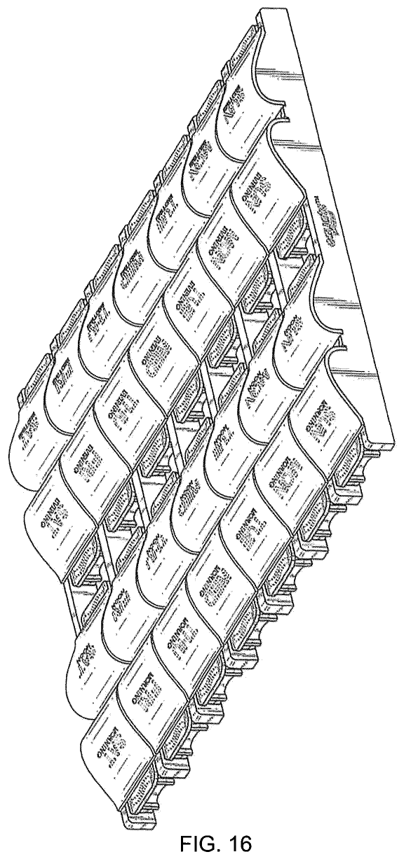

FIG. 16 is a top, rear and left side perspective view of the four row pillbox.

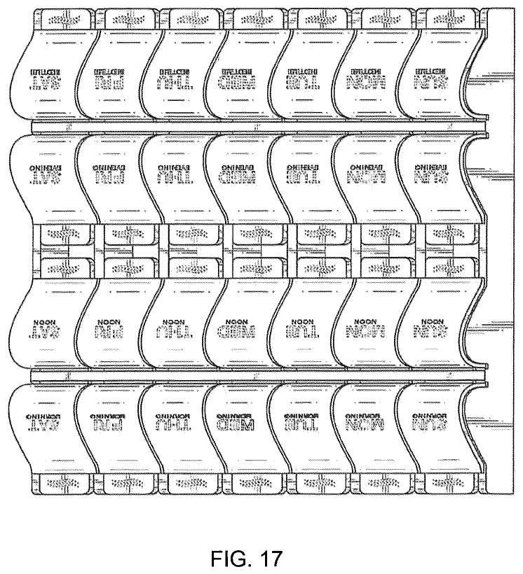

FIG. 17 is a top and left side perspective view of the four row pillbox.

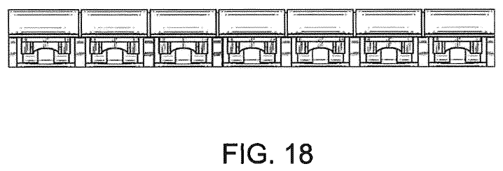

FIG. 18 is a front view of the four row pillbox.

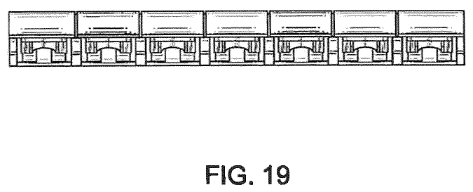

FIG. 19 is a rear view of the four row pillbox.

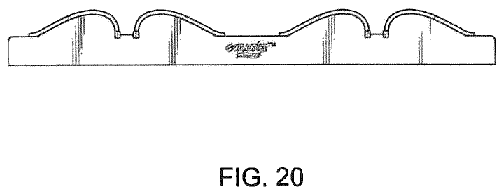

FIG. 20 is a left side view (viewer's perspective) of the four row pillbox.

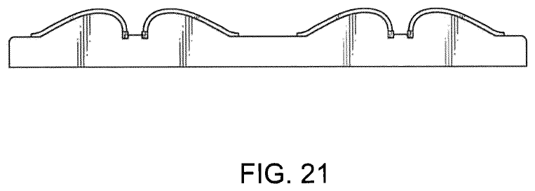

FIG. 21 is a right side view (viewer's perspective) of the four row pillbox.

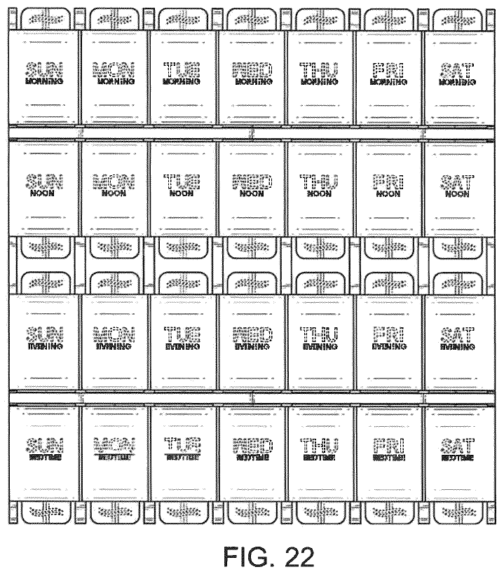

FIG. 22 is a top view of the four row pillbox.

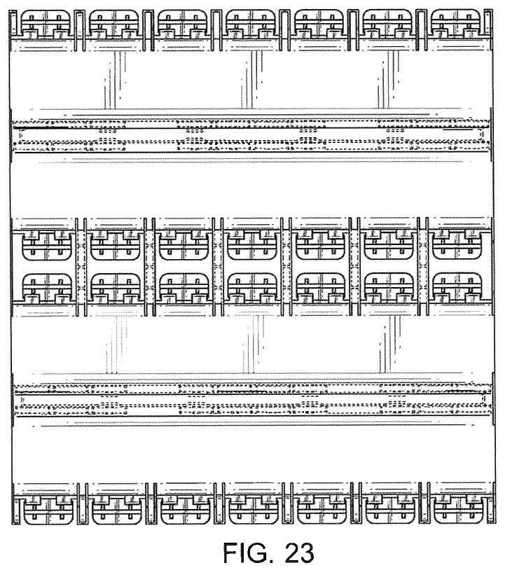

FIG. 23 is a bottom view of the four row pillbox.

Next described are details of an exemplary single row pillbox, having seven cells, to cover a week's worth of pills for an individual user. This embodiment has only one row of cells, and is thus most efficient for an individual who takes one or more pills in one shot, each day of the week. The cells can, of course, have different pills in the set of pills taken each day, the key being that one group of pills may be taken at a set time each day. As described below, when it is necessary for an individual to take a set of pills more than once per day (regardless of the contents of the set) each week, then the two-row pillbox, or four-row pillbox, embodiment is more appropriate. Each of these alternate embodiments is described below.

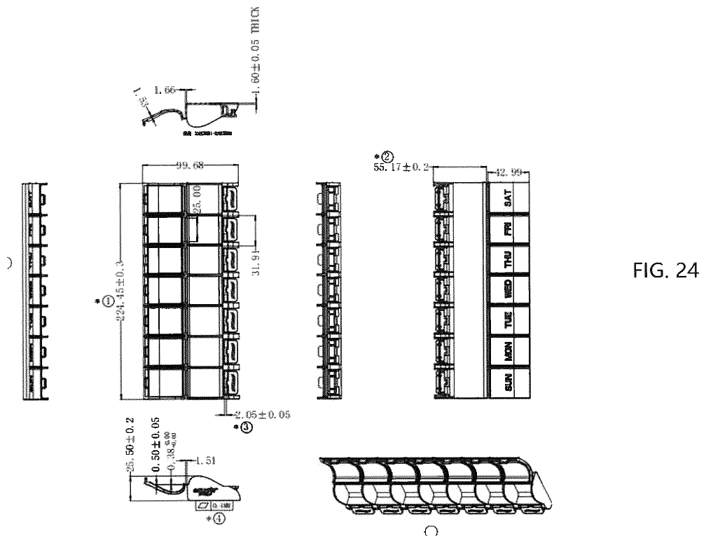

FIG. 24 illustrates exemplary dimensions for an example one row pillbox. FIG. 24 shows example dimensions for each of the base portion and the cover portion of the single row pillbox. The pillbox has a bottom surface, and a back wall, and each cell further has two sidewalls and a front wall. Interior cells share a common sidewall between them, as shown. The example pillbox may be made of, for example, polypropylene (“PP”), and may have a glossy platform. The material thickness may be, for example, 1.6 mm for the bottom surface, 1.53 mm for the cover surfaces, and 1.66 mm for the back wall of the cells. Other thicknesses may be used, depending upon the properties of the material selected, and desired robustness.

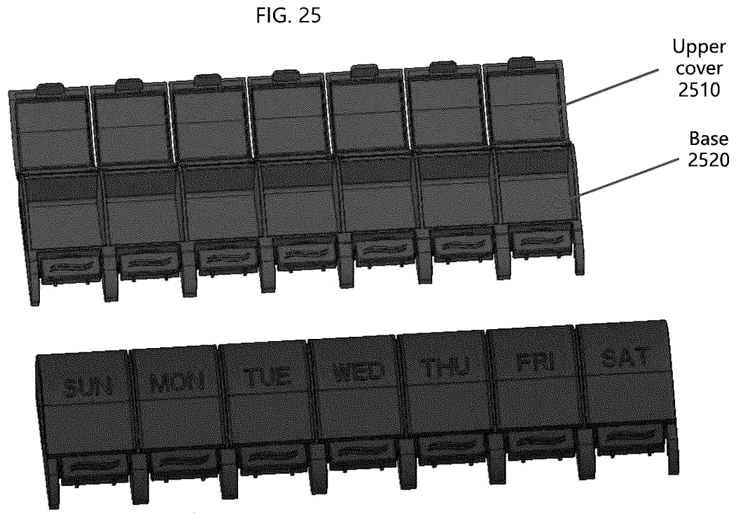

FIG. 25 illustrates details of the example single row pillbox of FIG. 24. There is shown an upper cover 2510 and a base 2520. In embodiments, the upper cover and base may be formed using integrated molding. In this example there are seven cells, and the upper cover has the day of the week associated with each cell engraved on the mold, as shown. Thus, from left to right they are labelled on the upper over as “SUN”, “MON”, “TUE”, “WED”, “THU”, “FRI” and “SAT.” At the front of each cell is a push button (shown with two wavy horizontal lines on it), by means of which a user pushes down, which pulls the button forward as well, as described below, and opens the cell.

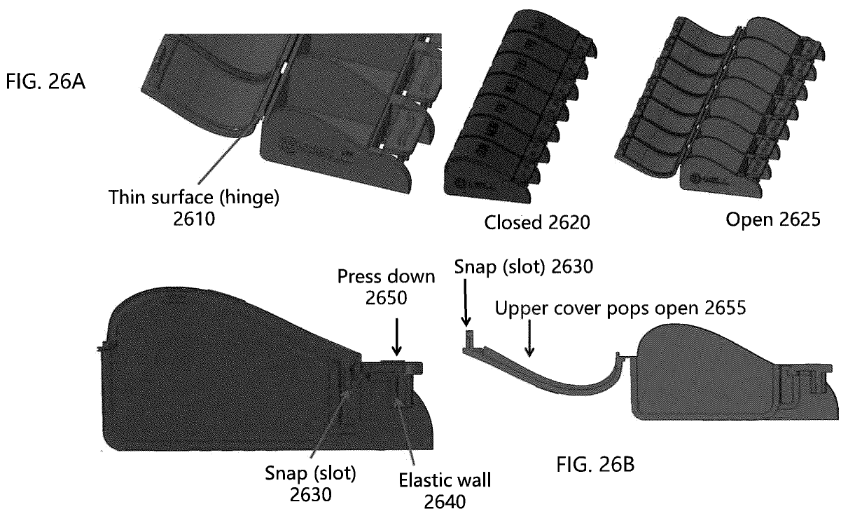

FIGS. 26A and 26B illustrate the hinge of the upper cover, and opening and closure details of the single row pillbox of FIG. 24.

FIG. 26A illustrates the upper cover activity structure. As shown in the figure on the left, a thin surface hinge structure 2610 is made at the connection between the upper cover and the back wall of the base. In some embodiments, PP material may be selected for the hinge structure (and the entire upper cover) to enhance toughness and ensure that the upper cover does not break off during opening and closing. The figures in the middle and far right of FIG. 26A illustrate the upper cover in its closed 2620 and open 2625 configurations.

FIG. 26B illustrates the opening and closing structure of the upper cover in enlarged detail, in cross section. The figure on the left of FIG. 26B shows the exemplary pillbox cell in the closed position. In order to open the pillbox cell, a user presses down 2650 on the push button, which causes the elastic wall 2640 provided at the front of the cell to move (actually rotate) forward, thereby releasing a buckle (e.g., a male protrusion) from being inside the female snap 2630 (may also be described as a slot, and may be a horizontal slot) and the upper cover pops open 2655.

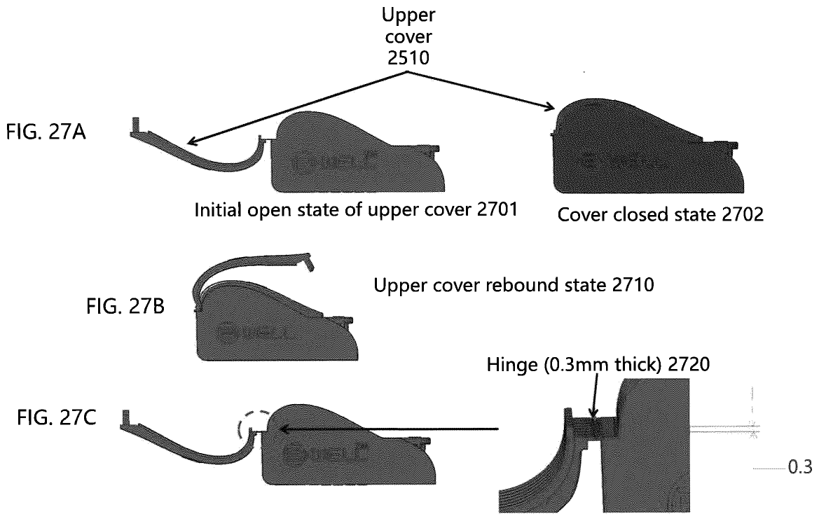

FIGS. 27A, 27B and 27C illustrate further details of the open and closed states of cells of the single row pillbox of FIG. 24.

With reference to FIG. 27A, initially the upper cover 2510 of the device is in an open state 2701. After the device is closed 2620, and the cell is now in cover closed state 2702, the stress on the hinge connecting the upper cover to the back wall is released (due to the hinge no longer needing to bear the weight of the cover in the open state), and there will be a rebound force developed in the closed state to promote the upper cover to return to the initial state 2701 of the raw material when the cover is released. The operation of this rebound force is shown as upper cover rebound state 2710, in FIG. 27B, where the upper cover snaps up or “pops up”, following the release of the upper cover by a user pushing down on the push tab, as described below. In general, the size of this upper cover rebound force is limited by the compression of the hinge, so that the device does not fully return to the initial fully open state 2701, where the upper cover is fully opened to its maximum extent. In embodiments, the upper cover can rebound upwards a certain distance as shown in FIG. 27B.

In alternate embodiments, the force and stroke of the rebound may be increased, by increasing further the thickness of the hinge, such that a greater upper cover rebound may be obtained. However, there is a limit on the thickness, where for a given material, too much thickness may result in overstressing of the device, and the upper cover possibly breaking after a certain number of openings and closings. Thus, in embodiments, strength of the material and thickness of the hinge must be coordinated, if greater upper cover rebound is desired.

FIG. 27C illustrates detail of the hinge structure that connects the upper cover 2510 to the vertical back wall. As shown, the hinge may be thin, in this example 0.3 mm thick, as shown at 2720 at the right image of FIG. 27C, which itself is a magnification of the indicated area in the left image of FIG. 27C.

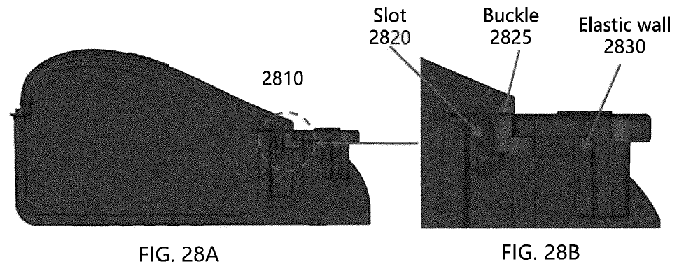

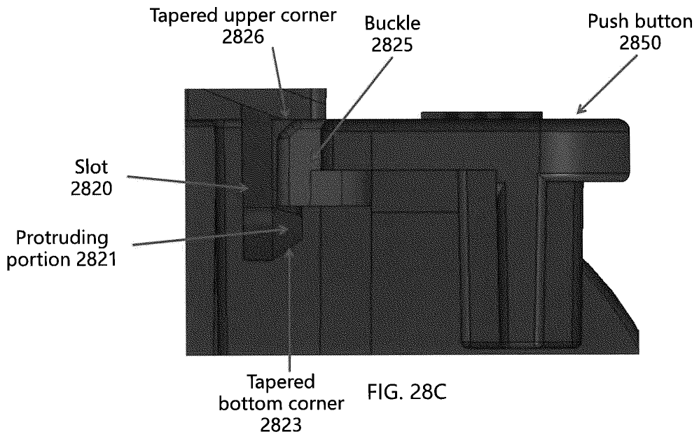

FIG. 28A illustrates a single cell of an exemplary pillbox in a closed position. In this position, the upper cover is held closed through the design of a buckle 2825, which may be described as a male protrusion, that fits into a female slot 2820, provided on top of a bottom lip or protruding portion on slot 2820, as shown, and described below with reference to FIG. 28C.

FIG. 28B shows a magnified version of the slot and buckle mechanism of FIG. 28A, and FIG. 28C shows a further magnified version of the buckle and slot of FIG. 28B. As shown, in embodiments, buckle 2825 may be provided with a tapered upper corner 2826, to allow the bottom surface of the protruding portion 2821 of slot 2820 to easily slide over, and then sit under, buckle 2825 when a user closes the cell by pushing down on the upper cover. In embodiments, protruding portion 2821 also has a tapered bottom corner 2823, to facilitate sliding against or along tapered upper corner 2826 of the buckle when closing the cell, as the slot is pushed downwards along the buckle 2825. Finally, FIG. 28C also shows push button 2850, which a user pushes down on to decouple buckle 2825 from slot 2820 when opening the cell from a closed state, as next described.

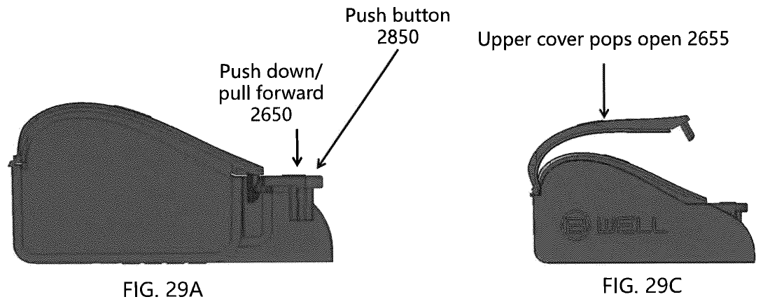

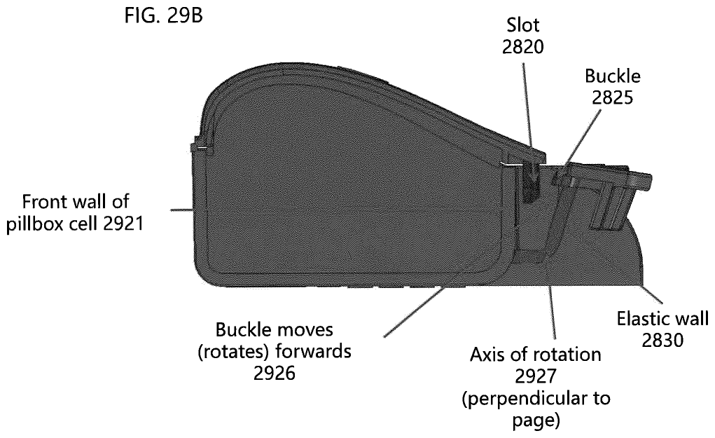

FIG. 29A illustrates an initial user action to open an exemplary cell of the single row pillbox. User pushes down 2650 on the push button 2850, which—as shown in FIGS. 28B and 28C—is connected to an elastic wall 2830 at the top of which the buckle is provided. In some embodiments, a force of 8-10 N is needed for this pushing operation. In response to the pushing force, as shown in FIG. 29B, buckle 2825 moves, or actually rotates, forwards (the front of the pill box cell being “forward” in this sense), thereby disengaging from slot 2820. The rotation is about axis of rotation 2927, which is shown (approximately) in FIG. 29B, which is the connection between the vertical portion of elastic wall 2830 and the horizontal portion of the elastic wall, which connects to the front wall of the pillbox cell 2921.

FIG. 29C illustrates how, now that the buckle and slot are disengaged, the upper cover of the pillbox cell pops open 2655 as a result of the upper cover now being freed.

Next described are details of an example two row pillbox, according to an embodiment. The basic structure of the two row pillbox is the same as that of the single row pill box, just scaled up to have two rows provided “back to back” so that the push tabs for each cell are always on an outer edge, and thus a user may rotate the two row pillbox to face them when accessing each row.

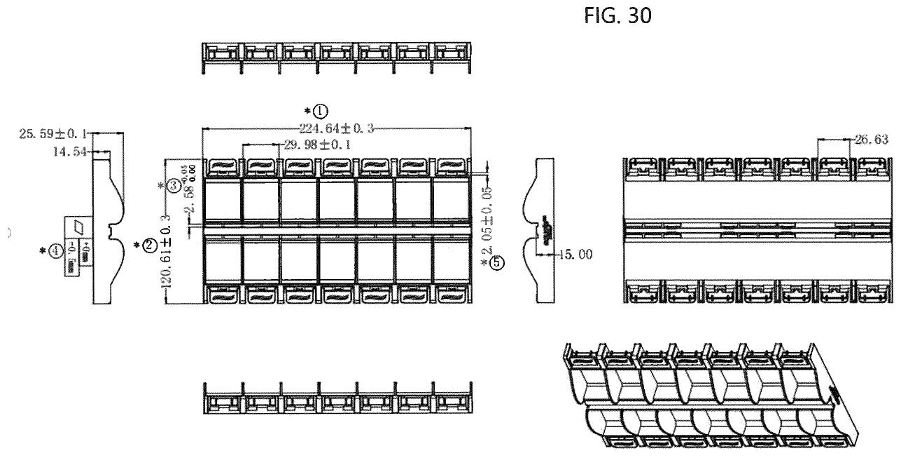

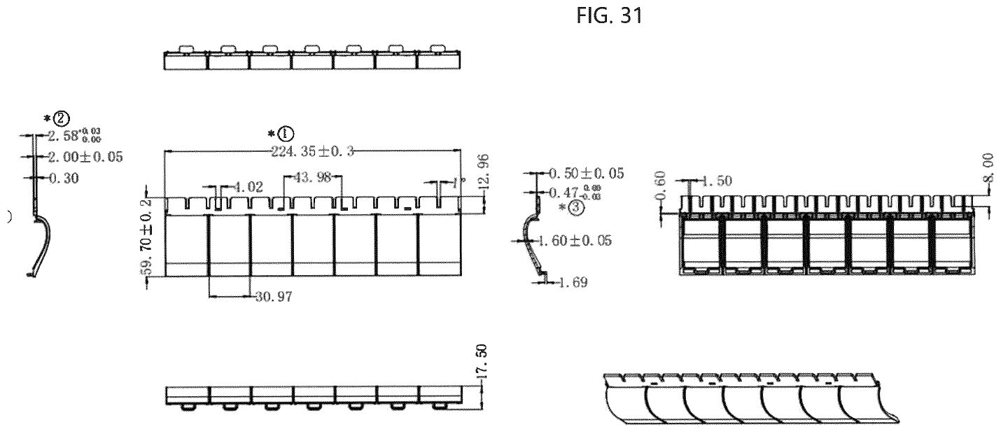

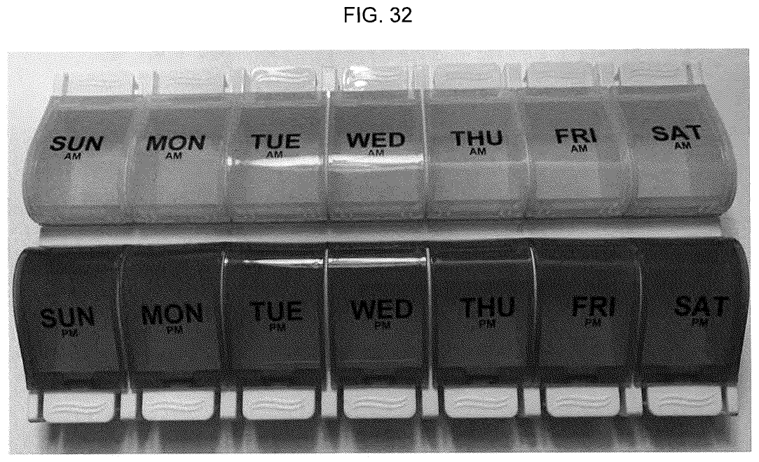

FIG. 30 provides example dimensions for the base structure for an exemplary seven cell double row pillbox, according to an embodiment. In this example the base may be made of polypropylene (“PP”), of a white material, by injection molding. The base material may have, for example, a 1.6 mm thickness, and a glossy surface. Examples of this base, together with the cover described in FIG. 31, are shown in each of FIGS. 32-35, described below. Other thicknesses may be used, depending upon the properties of the material selected, and desired robustness.

FIG. 31 provides example dimensions for a cover portion of an exemplary 7 cell double row pillbox, according to an embodiment. In embodiments, the top cover may be made of a transparent PP, with a thickness of, for example, 1.6 mm. In embodiments, the cover material may have a glossy surface.

FIG. 32 depicts an example embodiment of a double row pillbox with a white base portion, and two transparent cover portions, one light green, the other dark green, according to an embodiment. This example has the exemplary dimensions shown in FIGS. 30 and 31, discussed above. As shown, one row, a back row when facing a user, is designated as “AM” for each of the seven days, and a front row is designated as “PM.” Thus, a user who takes medications twice a day would find this example pillbox very useful in organizing his or her medications, and taking them all on schedule. The use of different colors for each row, reminds the user that each row is for a different time of day, and not to confuse medications from one time, with the other, even though it may be the same day.

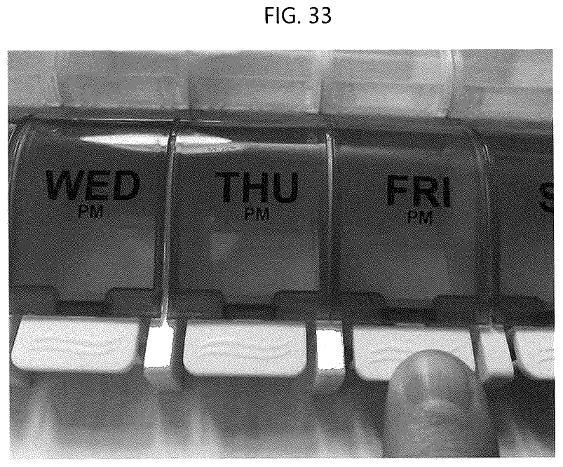

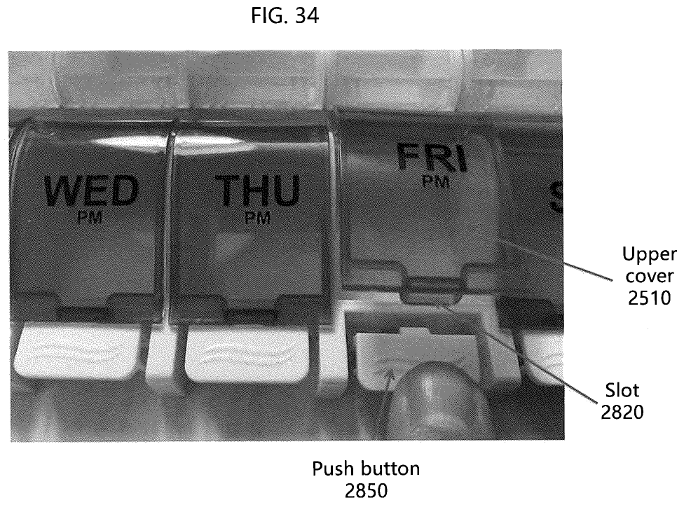

FIG. 33 depicts a close-up view of a few cells in the bottom row of the example pillbox of FIG. 32, namely those for Wednesday, Thursday and Friday, all for the “PM” time slot. Here, as shown, a user is starting to open the “FRI PM” cell by pushing down on a push button 2850 (see FIG. 34). This action will release upper cover 2510, by pulling forward a buckle (not shown, as it is here inside the slot) out of slot 2820.

FIG. 34 depicts the user shown in FIG. 33 completing the exemplary release action and the upper cover 2510 now having popped up. Thus, as shown, because when the push button 2850 is depressed, due to the elastic wall (or flexible member) that connects it to the front of the cell on the base portion (described above with reference to FIGS. 28C and 29B for a single row embodiment), the push button 2850 essentially rotates forwards (relative to a user) and pulls the buckle (as also described in connection with FIGS. 28C and 29B) out of slot 2820. This release of the buckle from the slot causes the upper cover 2510 to pop up, as noted above, because it is under some pressure due to the compression fit of the hinge.

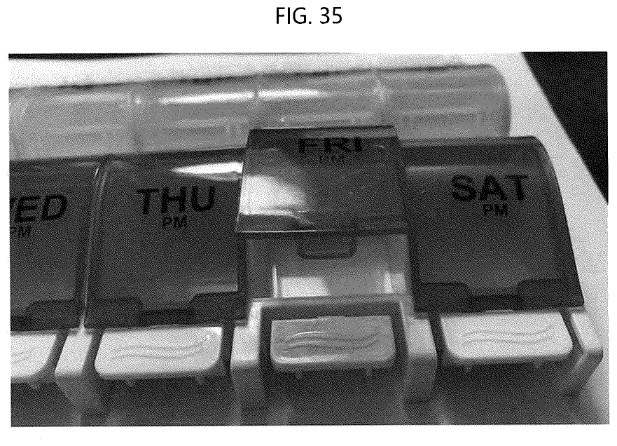

FIG. 35 illustrates the upper cover shown in FIG. 34 as now fully popped up, available for the user to easily compete opening of the cell and accessing its contents (or filling it with contents).

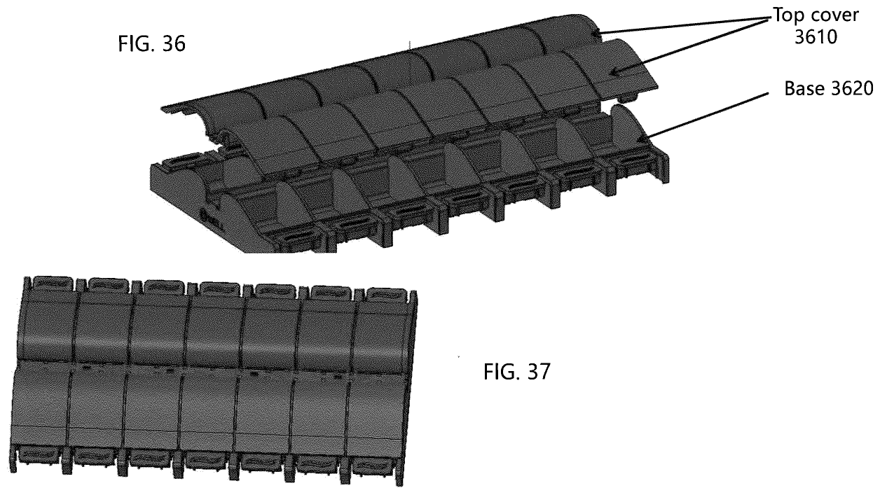

FIG. 36 illustrates expanded and “as assembled” views of an exemplary two cover portions and a two row back to back base portion, according to an embodiment. As shown in the upper image, the device, in this embodiment, comprises a single base portion 3620, and two upper cover portions 3610. The two cover portions have distinct and different colors, for ease of identification of the time of day (or other category as may be used to distinguish the two rows).

FIG. 37 illustrates the example two row pill box of FIG. 36, as assembled. As completed, in this embodiment there are a total of 14 cells, representing the morning (AM) and afternoon (PM) time for each day of a cycle of days, for example, seven days. In embodiments, day and time of day characters may be provided on the surface of the upper cover by printing using silk screen technology.

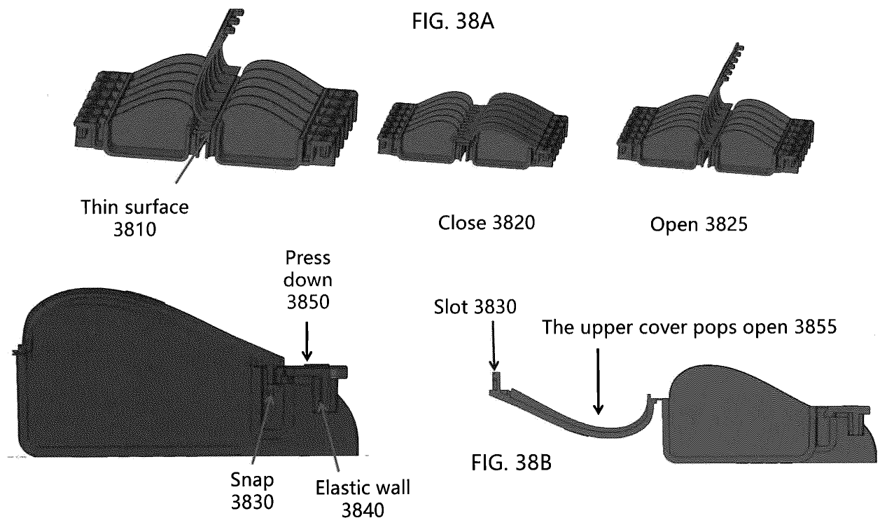

FIG. 38A illustrates, from left to right, the thin surface hinge structure 3810 connecting the upper cover and a vertical extension of the upper cover that is snapped into the base portion, as shown. FIG. 38A also shows the two row pillbox in closed 3820 and open 3825 positions, for one upper cover portion covering a single row of pill cells, according to an embodiment. As shown in the figure on the far left of FIG. 38A, the thin hinge structure is made at the connection between the upper cover and the base. For the hinge, PP material is selected to enhance toughness and ensure that the upper cover does not break during opening and closing. As noted above, the thickness of the hinge must not be made too large so as to cause breaking during opening and closing, but thick enough to provide sufficient compression or tension to create the upper cover “pop-up” effect when the upper cover is released by a user, as described above.

FIG. 38B illustrates an enlarged view of the base portion and upper cover portion of FIG. 38A in each of the closed and open positions for a single cell. The explanation of the closing and opening of the upper cover is the same as that provided above in connection with FIGS. 28 and 29, and need not be repeated. Briefly, as shown in the figure on the left of FIG. 38B, a user presses down 3850 on the elastic wall 3840, the buckle (not shown) rotates to the right, thereby releasing the buckle from the slot 3830, and the upper cover pops open 3855.

Next described is essentially a doubled version of the two-row pillbox, being a four row pillbox, each row including seven cells. It is understood, in embodiments, that a row may contain any number of cells, as may be useful for other organizational constructs than a week. For example, some people take a 10-day regimen of antibiotics, or different regimens of birth control pills. Thus, no example presented herein should be taken as limiting.

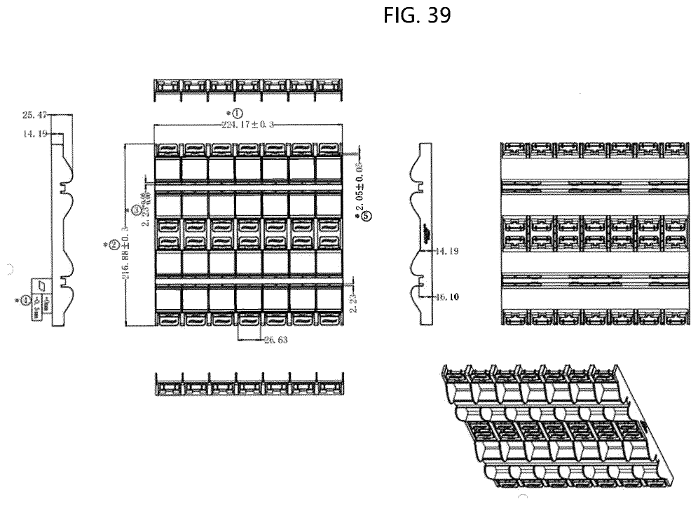

FIG. 39 provides example dimensions for the base portion of an exemplary 7 cell four row pillbox, according to an embodiment. The base, in this example, may be made of PP, and have a white color. The base may be made via injection molding, and may, for example, have a thickness of 1.6 mm.

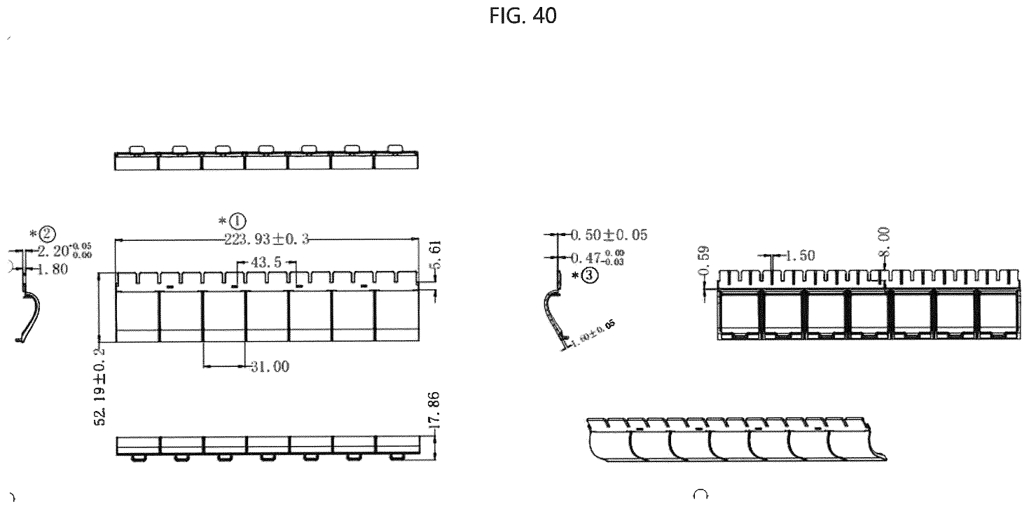

FIG. 40 provides example dimensions for an upper cover portion of the exemplary 7 cell four row pillbox of FIG. 39, according to an embodiment. Upper cover materials may be, for example, transparent PP, each upper cover having a thickness of, for example, 1.6 mm. In embodiments, the upper cover may have a glossy surface. Other thicknesses may be used, depending upon the properties of the material selected, and desired robustness.

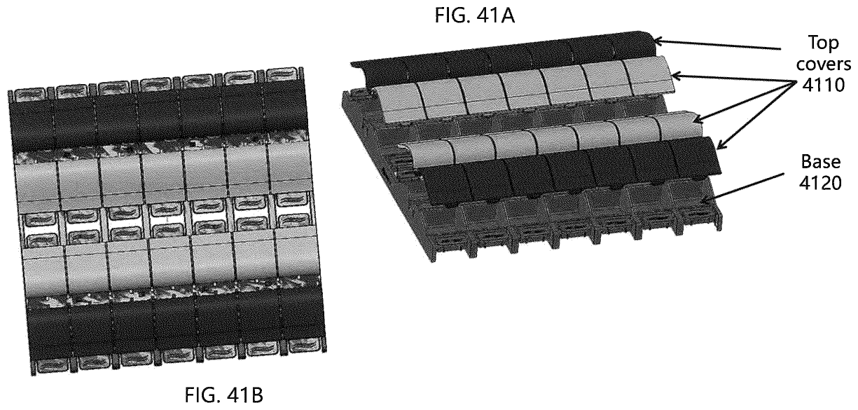

FIG. 41A illustrates four exemplary upper covers 4110 and a single base 4120, for an exemplary 7 cell four row pillbox, according to an embodiment. As shown in FIG. 41B, the closed state of the pillbox of FIG. 41A, the exemplary device, as assembled, provides a 28-cell pillbox in total.

In general a pillbox according to the present disclosure may have one or more rows, each with a set of M cells, for a total of i*M cells overall, where i is the number of rows.

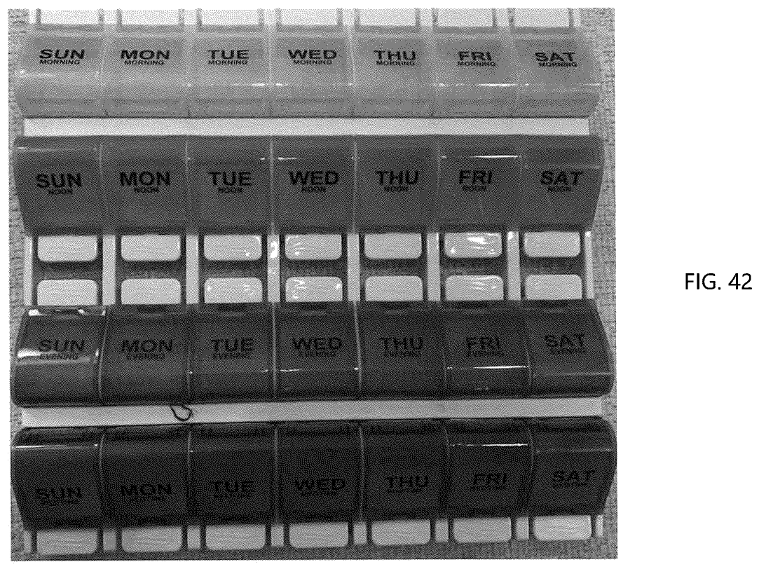

FIG. 42 depicts an example embodiment of a four row pillbox with a white base portion, and four colored cover portions, allowing a user to distinguish each row, according to an embodiment. This example was created using the exemplary dimensions of FIGS. 39 and 40.

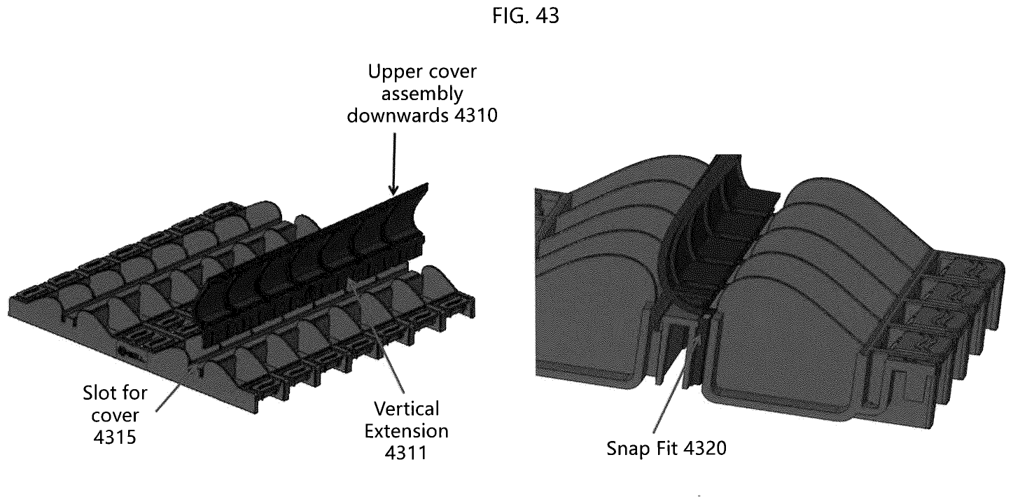

FIG. 43 illustrates assembly of an example four row seven day pillbox, in accordance with an embodiment. As shown in left image, an individual one (of the four, in total) upper cover assembly 4310 may be snap fitted into corresponding slot 4315 on the base portion. In embodiments, a vertical planar extension 4311 of upper cover assembly is inserted into slot 4315 and secured by a snap fit 4320, as shown. Vertical extension 4311 may have vertical cutouts in it, as shown, so that it can be guided into the slot 4315 and be snapped in place. In other embodiments, the upper cover need not have such a vertical extension 4311, and the hinge of the upper cover assembly may be attached to a back wall of the base portion directly, via any available welding or fastening technique, or, if available, an integrated molding technique.

In alternate embodiments, for all of the disclosed embodiments described above, the male and female aspects of the buckle and slot for the closure mechanism for each cell may be reversed. In such alternate embodiments, a male type protrusion provided on an outer edge of an upper cover, may be configured to mate with a female type slot provided at the back, for example, of the push button, the push button connected to an elastic wall provided at the front of a cell on, and connected to, or integrated within, the base portion, as described above.

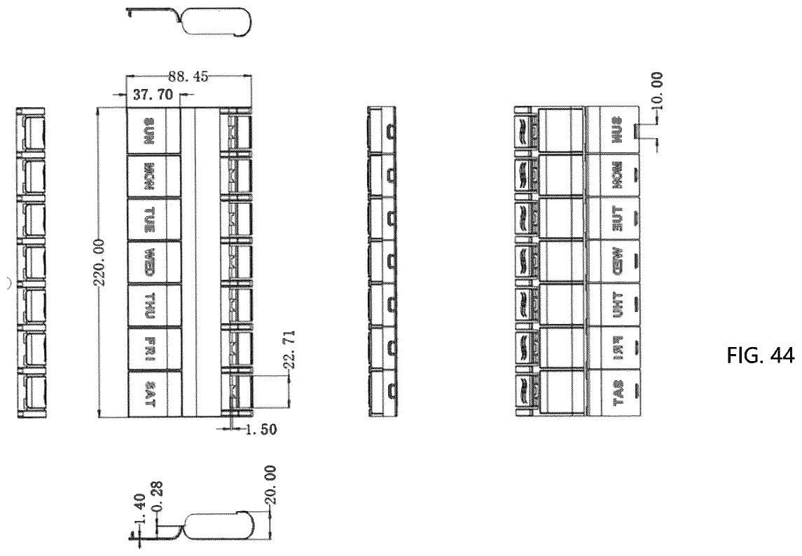

FIG. 44 illustrates exemplary dimensions for an example one row pillbox according to an alternate embodiment having rounded corners, and where the cover, when closed, completes a clean and sleek perimeter together with the base. FIG. 44 shows example dimensions for each of the base portion and the cover portion of the single row pillbox. The pillbox has a bottom surface, a back wall, and each cell has two sidewalls and a front wall. Interior cells share a common sidewall between them. The example pillbox may be made of, for example, polypropylene, and may have a glossy platform. The material thickness may be, for example, 1.6 mm for the bottom surface, 1.53 mm for the cover surfaces, and 1.66 mm for the back wall of the cells. Alternatively the cover surface may have a thickness of 1.40 mm, and the bottom surface 1.50 mm. Other thicknesses may be used, depending upon the properties of the material selected, and desired robustness, or lightness.

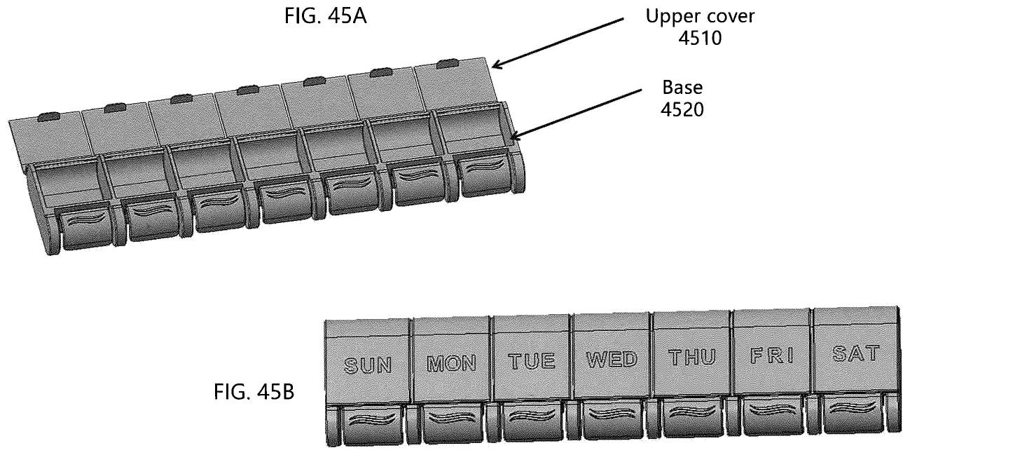

FIGS. 45A and 45B illustrate a rendering of an example pill box according to the design of FIG. 44. FIG. 45A depicts the pill box in an open state, and FIG. 45B depicts it in a closed state. With reference to FIG. 45A, the upper cover 4510 and base 4520 may be integrally formed, with a rounded shape for a “sleek” look and feel.

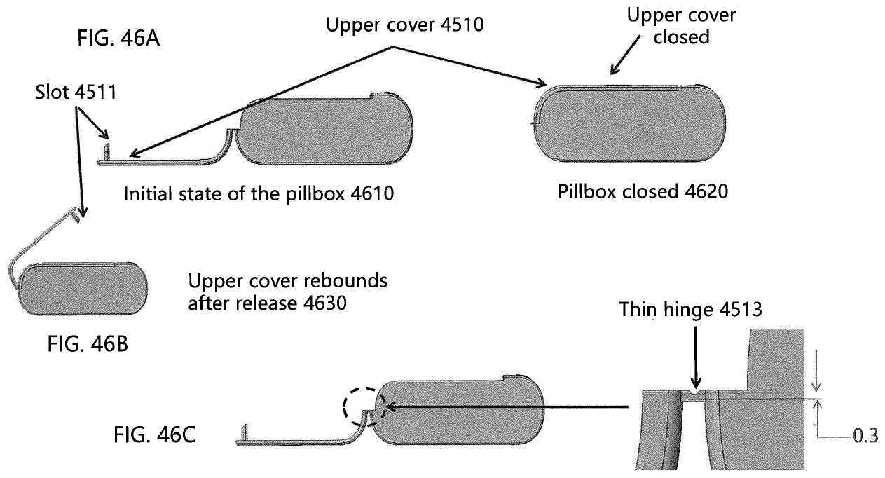

FIG. 46A shows, in the figure on the left, the initial state of the pillbox, where the upper cover 4510 is in an open state. After the pillbox is closed, at 4620, where, obviously, the upper cover is in the closed position, the stress on the hinge (which adheres the upper cover 4510 to the base) is released, and there will then develop a rebound force, due to the compression of the hinge, to promote the upper cover to return to the initial state of the pillbox 4610, as illustrated in FIG. 46B. FIG. 46A also shows the slot 4511 on the end of the upper cover 4510

As noted above, when using such a compression fit of the hinge to generate the rebound force, the size of the rebound force is limited, and the device will not pop up on its own to return to the initial state 4610. It can rebound a certain distance, as shown in FIG. 46B. Additional force, to a limit, may be achieved by increasing the thickness of the hinge, subject, of course, to the limit of not causing breaking of the pillbox during opening and closing, as noted above.

The left image of FIG. 46C is the exemplary pillbox in its open state, with an indicated area in which the hinge is provided. The right image of FIG. 46C shows magnified detail of the hinge area indicated in the left image. As shown in the right image of FIG. 46C, a thin (0.3 mm thick) hinge structure is made at the turning end of the upper cover and base, and PP material is selected to enhance toughness and ensure that the upper cover does not break during opening and closing.

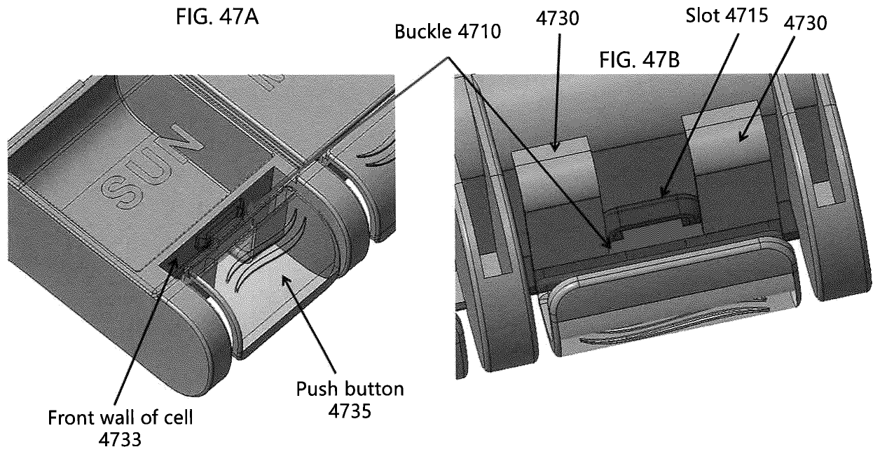

FIG. 47A is a rendering of the pillbox of FIG. 45, showing a front region of a single cell. Shown is the front wall of the cell 4733, and the buckle 4710, which is, in this closed state of the pillbox, inserted into a corresponding slot 4715 (shown in FIG. 47B). FIG. 47B is an underside view of the rendering of FIG. 47A, which provides detailed views of the buckle and slot. Here is shown buckle 4710 inserted into slot 4715. Also shown are two connectors 4730, which are analogous to the elastic wall described above, for example, as item 2830 with reference to FIG. 29B. Connectors 4730 are elastic, and thus bendable, and they connect the push button 4735, which includes the buckle 4710 at its rear top portion, to the front wall of cell 4733.

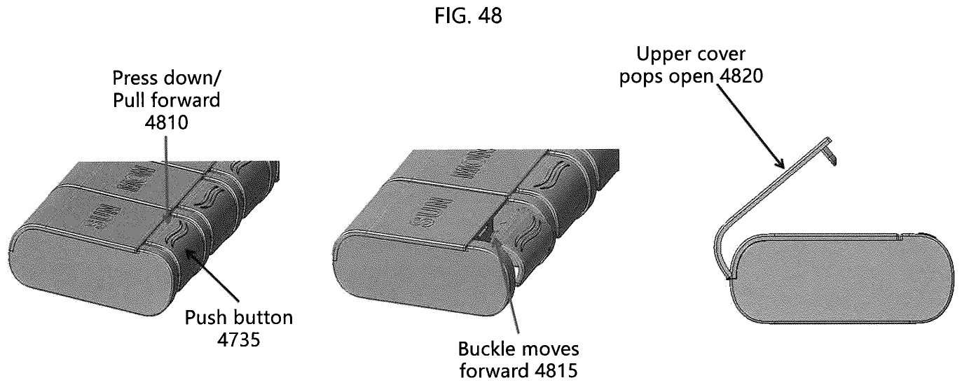

FIG. 48 illustrates a perspective view of the opening of a cell of the example pillbox of FIG. 45 from a closed state to the upper cover pop up state. Here, as shown in the left image, a user pushes down (which includes pulling the push button forward) 4810 on the push button 4735, which moves the buckle forward 4815 and out of the slot, as shown in the middle image. In this example, a force of 8-10N is needed to push down (4810) the push button. This release, as shown in the right image, causes the upper cover to pop open 4820, due to the rebounding force.

Next described are alternate implementations of the closure mechanism between, both as described above, and in an alternate embodiment, which reverses the “male protrusion on push button” aspect of the first embodiment.

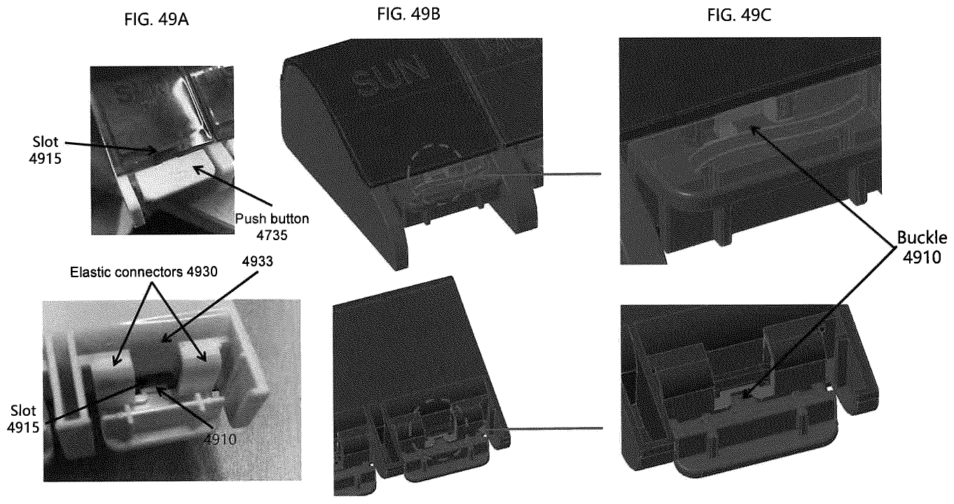

FIG. 49A shows top and bottom views of an example pillbox with a first closure mechanism according to an embodiment. This example is one cell of the 4-row pillbox described above. There is shown, as described above, slot 4915 provided in the upper cover into which a buckle is inserted to close the cell. Also shown in push button 4735, used to open the cell. The bottom image shows slot 4915 from the bottom, and buckle 4910 inserted into it, as well as front wall 4933 and the two elastic connectors 4930 that attach push button 4735 to the front wall 4933 of the cell. This closure mechanism is the same one described above, for example, with reference to FIG. 29B.

FIG. 49B shows top and bottom view renderings of the example pillbox of FIG. 49A, showing areas to be enlarged to illustrate the closure mechanism.

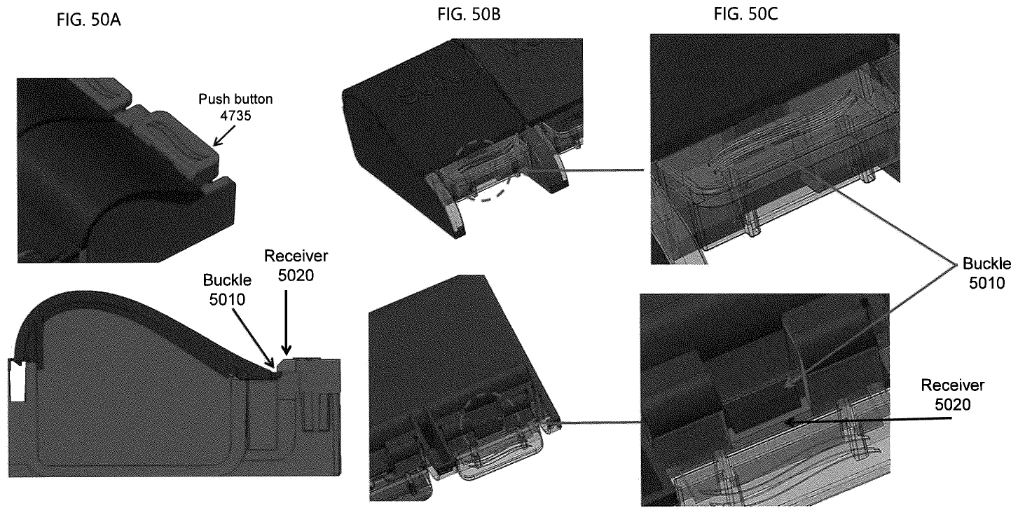

FIG. 49C shows the indicated enlarged areas of the top and bottom renderings of FIG. 49B. In FIG. 49C, there is seen the buckle 4910, in blue, as inserted into the slot 4915 shown in red. This is a “male buckle on push button” that fits into a “female slot on upper cover” embodiment. FIG. 50, next described, reverses the roles of the buckle and slot, and provides the buckle on the upper cover, with a receiver (or receiving slot) provided on the rear portion of the push button.

FIG. 50A shows top and bottom view renderings of an example pillbox with an alternate closure mechanism according to an alternate embodiment. The alternate closure mechanism includes buckle 5010 (shown in purple), now provided on the front of the upper cover, and buckle 5010 mates with a receiver 5020, now provided at the back portion of the upper surface of the push button 4735.

FIG. 50B shows top and bottom view renderings of the example pillbox of FIG. 50A, showing areas to be enlarged to illustrate the alternate closure mechanism of FIG. 50A. FIG. 50C shows the indicated enlarged areas of the top and bottom view renderings of FIG. 50B. Here in FIG. 50C are shown, in the upper image, buckle 5010, shown in purple, now protrudes from the upper front cover of this cell, and fits underneath receiver 5020, shown in red. In this upper view rendering, the push button 4735 is shown transparently, so to allow one to view the structures underneath. These structures are seen even more clearly in the bottom view of FIG. 50C, where the bottom of the buckle (in purple), attached to the upper cover, is shown fitting under the receiver 5020 (shown in red), the receiver thereby holding the upper cover under it, keeping the cell closed.

Alternatively, a slot or equivalent can be provided in the bottom (horizontal) surface of the receiver, to hold the buckle inside it during the closed state, in an analogous fashion to the situation of the embodiment of FIGS. 49, where the slot is provided in a vertical surface that protrudes downwards from the upper cover. By tapering the surfaces of buckle and receiver that interact and slide along each other during closing, the cell can be easily and readily opened in such an alternate version of the embodiment of FIG. 50.

Methods of manufacture of the disclosed embodiments are also understood as included in the present disclosure. For example, a method may include providing a multi-cell pillbox, comprising: providing a base portion comprising a set of N cells organized in one or more rows, each row including M cells, and providing i top cover portions configured to respectively fit over the N cells, where i is a number of rows of the base portion, each cover portion including an individual cover for each of M cells, and configuring the M individual covers to respectively close over M cells in a row of the base portion, and providing each individual cover with a slot, configured to receive an insert. The method may further include providing in a front portion of each cell of the base portion, a push tab connected to the base portion via one or more flexible members, the push tab including, at a rear portion thereof, a protrusion, the protrusion configured to be inserted into a slot of a corresponding individual cover for that cell.

As another example, a method may include providing a base portion comprising a set of N cells organized in one or more rows, each row including M cells, and providing i top cover portions configured to respectively fit over the N cells, where i is a number of rows of the base portion, each cover portion including an individual cover for each of M cells, and configuring the M individual covers to respectively close over M cells in a row of the base portion, providing each individual cover with a protrusion, configured to fit into a corresponding receiver. The method may further include providing, in a front portion of each cell of the base portion, a push tab connected to the base portion via one or more flexible members, and providing at a rear portion of the push tab, a receiver configured to mate with the protrusion of the individual cover for that cell.

Although particular embodiments, aspects, and features have been described and illustrated, it should be noted that the invention described herein is not limited to only those embodiments, aspects, and features, and it should be readily appreciated that modifications may be made by persons skilled in the art. The present application contemplates any and all modifications within the spirit and scope of the underlying invention described and claimed herein, and all such embodiments are within the scope and spirit of the present disclosure.

What is claimed:

1. A multi-cell pillbox, comprising:
a base portion comprising a set of N cells organized in one or more rows, each row including M cells;
i top cover portions configured to respectively fit over the N cells, where i is a number of rows of the base portion, each cover portion including an individual cover for each of M cells, the M individual covers configured to respectively close over M cells in a row of the base portion, each individual cover including a slot, configured to receive an insert;
wherein, in a front portion of each cell of the base portion, there is provided a push tab connected to the base portion via one or more flexible members, the push tab including, at a rear portion thereof, a protrusion, the protrusion configured to be inserted into a slot of a corresponding individual cover for that cell.

2. The multi-cell pillbox of claim 1, the top cover portions further including a hinge connecting each individual cover to a rear wall of a row of the base portion.

3. The multi-cell pillbox of claim 2, wherein the hinge has a thickness T, configured to generate tension between an individual cover and a corresponding cell of the base portion when closed.

4. The multi-cell pillbox of claims 1-3, wherein N is one of 7, 14 or 28.

5. The multi-cell pillbox of claims 1-3, wherein i is one of 1, 2 or 4.

6. The multi-cell pillbox of claims 1-3, wherein the base and cover are made of polypropylene.

7. The multi-cell pillbox of claims 1-3, wherein M is 7.

8. A multi-cell pillbox, comprising:
a base portion comprising a set of N cells organized in one or more rows, each row including M cells;
i top cover portions configured to respectively fit over the N cells, where i is a number of rows of the base portion, each cover portion including an individual cover for each of M cells, the M individual covers configured to respectively close over M cells in a row of the base portion, each individual cover including a protrusion, configured to fit into a corresponding receiver;
wherein, in a front portion of each cell of the base portion, there is provided a push tab connected to the base portion via one or more flexible members, the push tab including, at a rear portion thereof, a receiver configured to mate with the protrusion of the individual cover for that cell.

9. The multi-cell pillbox of claim 8, the top cover portions further including a hinge connecting each individual cover to a rear wall of a row of the base portion.

10. The multi-cell pillbox of claim 9, wherein the hinge has a thickness T, configured to generate tension between an individual cover and a corresponding cell of the base portion when closed.

11. The multi-cell pillbox of claims 8-10, wherein N is one of 7, 14 or 28.

12. The multi-cell pillbox of claims 8-10, wherein i is one of 1, 2 or 4.

13. The multi-cell pillbox of claims 8-10, wherein the base and cover are made of polypropylene.

14. The multi-cell pillbox of claims 8-10, wherein M is 7.

15. A method of providing a multi-cell pillbox, comprising:
providing a base portion comprising a set of N cells organized in one or more rows, each row including M cells;
providing i top cover portions configured to respectively fit over the N cells, where i is a number of rows of the base portion, each cover portion including an individual cover for each of M cells;
configuring the M individual covers to respectively close over M cells in a row of the base portion, and providing each individual cover with a slot, the slot configured to receive an insert; and
providing in a front portion of each cell of the base portion, a push tab connected to the base portion via one or more flexible members, the push tab including, at a rear portion thereof, a protrusion, the protrusion configured to be inserted into a slot of a corresponding individual cover for that cell.
